(19) United States
(12) Patent Application Publication
(10) Pub. No.: US 2008/0275990 A1
(43) Pub. Date: Nov. 6, 2008

(54) METHOD AND SYSTEM FOR SELECTING, IN A VEHICLE, AN ACTIVE PREFERENCE GROUP

(75) Inventors: Krishnaswamy Venkatesh Prasad, Ann Arbor, MI (US); Ryan J. Skaff, Belleville, MI (US); Raymond C. Siciak, Ann Arbor, MI (US); Thomas J. Giuli, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/742,886

(22) Filed: May 1, 2007

(51) Int. Cl. G06F 15/173

(52) U.S. Cl. 709/225

(57) ABSTRACT

An occupant of a vehicle is presented with discussion groups of interest to the occupant. The discussion groups are selected based on the degree to which interests of friends of the occupant coincide with the interests of the occupant. Once a discussion group is chosen, a telematics gateway connects the occupant to the discussion group.

### BACKGROUND OF THE INVENTION

1. Field of the Invention

The invention relates to methods and systems for selecting, in vehicles, active preference groups.

2. Discussion

Chat groups allow people to communicate about particular topics. While driving, occupants of vehicles may desire to communicate with others having similar interests or hobbies.

### SUMMARY

Embodiments of the invention may take the form of a method for selecting, in a vehicle, an active preference group. The method includes receiving an occupant identifier, retrieving members of a social network associated with the occupant identifier, and retrieving interest information associated with the occupant identifier. The method also includes retrieving interest information associated with the members of the social network, retrieving preference groups associated with the members of the social network, and determining common interest metrics between an occupant associated with the occupant identifier and each member of the social network. The method further includes selecting preference groups based on the common interest metrics, determining whether the selected preference groups are active, presenting active preference groups, receiving input selecting one of the active preference groups, and connecting a communication module with a host of the selected one active preference group.

Embodiments of the invention may take the form of a system for selecting, in a vehicle, an active preference group. The system includes an identification module configured to receive an occupant identifier. The system also includes a communication module configured to retrieve members of a social network associated with the occupant identifier, retrieve interest information associated with the occupant identifier, and retrieve interest information associated with the members of the social network. The communication module is further configured to retrieve preference groups associated with the members of the social network and connect with a host of a selected active preference group. The system further includes a processing module configured to determine common interest metrics between an occupant associated with the occupant identifier and each member of the social network, select preference groups based on the common interest metric, and determine whether the selected preference groups are active. The system still further includes a presentation module configured to present active preference groups and an input module configured to receive input selecting one of the active preference groups.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a block diagram of a vehicle system for linking an occupant of a vehicle to a discussion session and shows a computing platform in communication with a display, control module, and telematics gateway, and the telematics gateway in communication with remote network servers.

FIG. 2 is a graphical representation of members of a circle of friends of the occupant of FIG. 1 and shows the occupant at N0, friends of the occupant at N1-N4, and friends of the friends of the occupant at N5-N10.

FIG. 3A is a tabular representation of the interests of the occupant of FIG. 1 and two members of the circle of friends.

FIG. 3B is a flow chart of a procedure to determine the similarity of interests between the occupant of FIG. 1 and the members of the circle of friends.

FIG. 4 is a graphical representation of the similarity of interests between the occupant of FIG. 1 and the members of the circle of friends and shows those members with interests similar to the occupant closer to the occupant.

FIG. 5A is a tabular representation of discussion groups to which the two members of FIG. 3A subscribe.

FIG. 5B is a series of tabular representations of the discussion groups of FIG. 5A and shows the discussion groups first sorted by the similarity of interests between each member of FIG. 3A, next sorted by whether the discussion groups are active, and finally displayed according to a rule.

FIG. 6 is a flow chart of a method for selecting, in a vehicle, an active preference group in accordance with an embodiment of the invention.

### DETAILED DESCRIPTION

Embodiments of the invention enable communications between highly mobile groups of people. A user interface may allow a driver to browse or search for chat groups of interest, join those groups, and speak over a voice interface with other members of the group. A driver may search for chat groups based on what the groups are discussing or by utilizing social network information.

Embodiments of the invention may identify a user in a variety of ways such as by the user depressing a key fob or by proximity to the vehicle using a keyless start feature. A button may also be depressed on a control screen to identify the user.

Using a transceiver or other wireless network communication device, e.g., WiFi, WiMAX, 3G, etc., the vehicle connects to social networking websites where the user has accounts via web services protocols, e.g., SOAP, HTTP. Once connected, the vehicle downloads personal information about the user such as their interests and hobbies as well as their social network.

Embodiments of the invention use social networking data and a user's interests to compute a metric that determines the similarity between the user and every member of his social network. For example, P1 (the user), and P2 and P3 (members of P1's social network) have interests as follows: P1-college football, rock music, and automotive design; P2-college football, automotive design, and classical music; and, P3-basketball, country music, and sailing. In a virtual sense, P1 is closer to P2 because they share more interests, e.g., college football and automotive design. P3 is further away than the other two. If there is a fourth person, P4, that is not interested in any of the sports, hobbies, and music of P1, P2, and P3, that person would be furthest away.

Embodiments of the invention permit a driver to initiate a search for new channels to join if the vehicle finds persons with similar interests to the driver. For each similar person, P, the vehicle downloads a list of channels to which P subscribes. Each channel may be given a rank based on a measure of the similarity between P and the driver. The channels of P's who are more similar to the driver may be ranked higher than the channels of P's who are less similar to the driver.

Once the vehicle has collected a list of channels of interest to the driver, the vehicle may sort the channels such that the channels of most interest to the driver are at the top of the list. The vehicle may then contact remote servers via its transceiver and query for current activity associated with the channels. In this context, an active channel may be one in which other drivers are currently logged in and chatting.

Embodiments of the invention may limit the number of types of channels a passenger is allowed to access or join. For example, if the number of accessible channels is too large, the passenger may not be able to see all of the channels simultaneously on a built-in-display. In this case, the vehicle may present the list to the driver in chunks at a time, such that the driver's attention is not consumed with reading or listening to a large list of channels. The passenger may select a channel by depressing a button or issuing a voice command though a microphone with voice recognition capabilities.

Once the driver has made his selection, the vehicle may contact a server via the vehicle's transceiver to get the hostname H of the server that hosts the requested channel. The vehicle then contacts H directly via its transceiver and transmits the driver's account information. This process logs the driver into the channel and after the process is complete, the driver can communicate, e.g., speak, with other people logged into the same account.

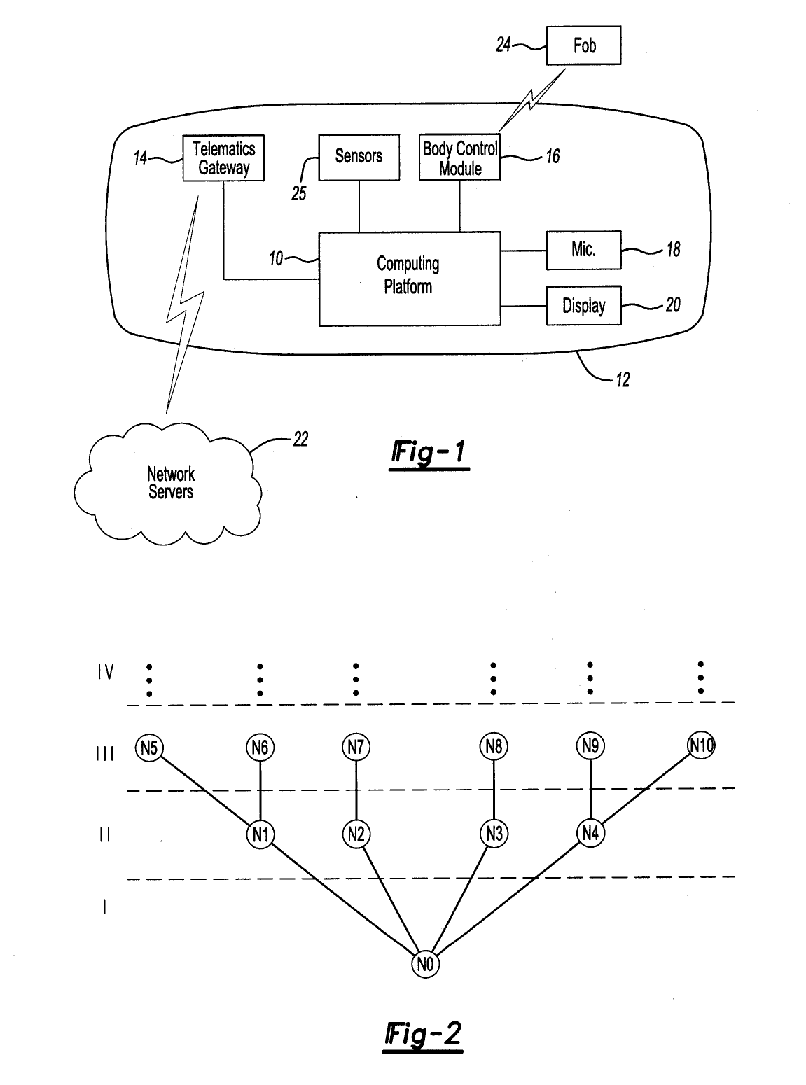

FIG. 1 is a block diagram of a vehicle system for linking an occupant to a discussion session. Computing platform 10, e.g., processor, of vehicle 12 communicates with telematics gateway 14, body control module 16, microphone 18, and display 20 via hard line connections. In alternative embodiments, one or more of the above may communicate with computing platform 10 in any desired fashion, e.g., a controller area network, wireless, flexray. Telematics gateway 14 communicates wirelessly with one or more remote network servers 22 such that information may be exchanged between computing platform 10 and network servers 22. Sensors 25, e.g., vehicle speed sensor, accelerator pedal position sensor, brake pedal position sensor, communicate vehicle speed, acceleration, and deceleration information to computing platform 10.

Computing platform 10 may identify an occupant of vehicle 12 in several ways. Body control module 16 may receive signals from key fob 24 that may be distinguished from other key fobs (not shown) for use with vehicle 12. These signals may therefore indicate an identity of a person associated with key fob 24. An occupant of vehicle 12 may speak their name into microphone 18. Also, display 20 may have a touch screen that permits an occupant to select their identity which is then communicated to computing platform 10.

Once computing platform 10 identifies the occupant of vehicle 12, computing platform contacts network servers 22 via telematics gateway 14 to gather circle of friend information for the occupant.

FIG. 2 is a graphical representation of members of a circle of friends of the occupant. The occupant is located at N0. Friends of the occupant are located at N1-N4. Friends of the friends of the occupant are located at N5-N10. Those friends located in lower levels, e.g., I, are closer to the occupant than those friends located in higher levels, e.g., II. The occupant, therefore, may or may not know the friends of the friends of the occupant at N5-N10.

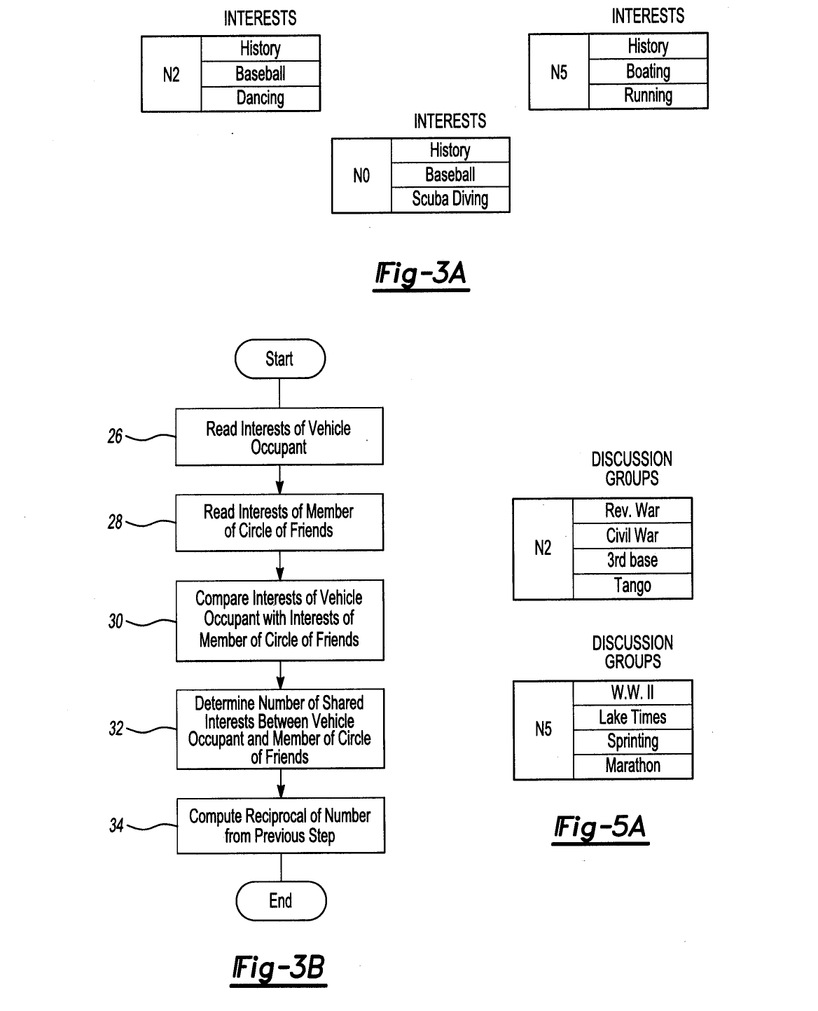

FIG. 3A is a tabular representation of the interests of the occupant, N0, and friends of the occupant located at N2 and N5. Network servers 22 hold similar information for most or all of the circle of friends of the occupant. N0 is interested in history, baseball, and scuba diving. N2 is interested in history, baseball, and dancing. N5 is interested in history, boating, and running. These interests are communicated from network servers 22 to computing platform 10 via telematics gateway 14.

FIG. 3B is a flow chart of a procedure to determine the similarity of interests between the occupant and the members of the circle of friends. At 26, computing platform 10 reads the interests of the occupant. At 28, computing platform 10 reads the interests of a particular member of the circle of friends, e.g., N2. At 30, computing platform 10 compares the interests of the occupant with the interests of N2. At 32, computing platform 10 determines the number of shared interests between the occupant and N2, e.g., 2-history and baseball. At 34, computing platform 10 computes the reciprocal of the number from step 32, e.g., 0.5. Computing platform 10 follows this procedure for each of N1-N10 where interest information is available. For example, N3 shares only a single interest with the occupant so the outcome of step 32 would be 1 and the outcome of step 34 would be 1. If no interests are shared in step 34, the outcome of step 34 is assigned a default value of 2. In alternative embodiments, determining the number of shared interests between the occupant and members of the circle of friends determines how similar the interests of the occupant are to the interests of the circle of friends. The similarity between the occupant and the circle of friends, however, may be determined in any suitable fashion.

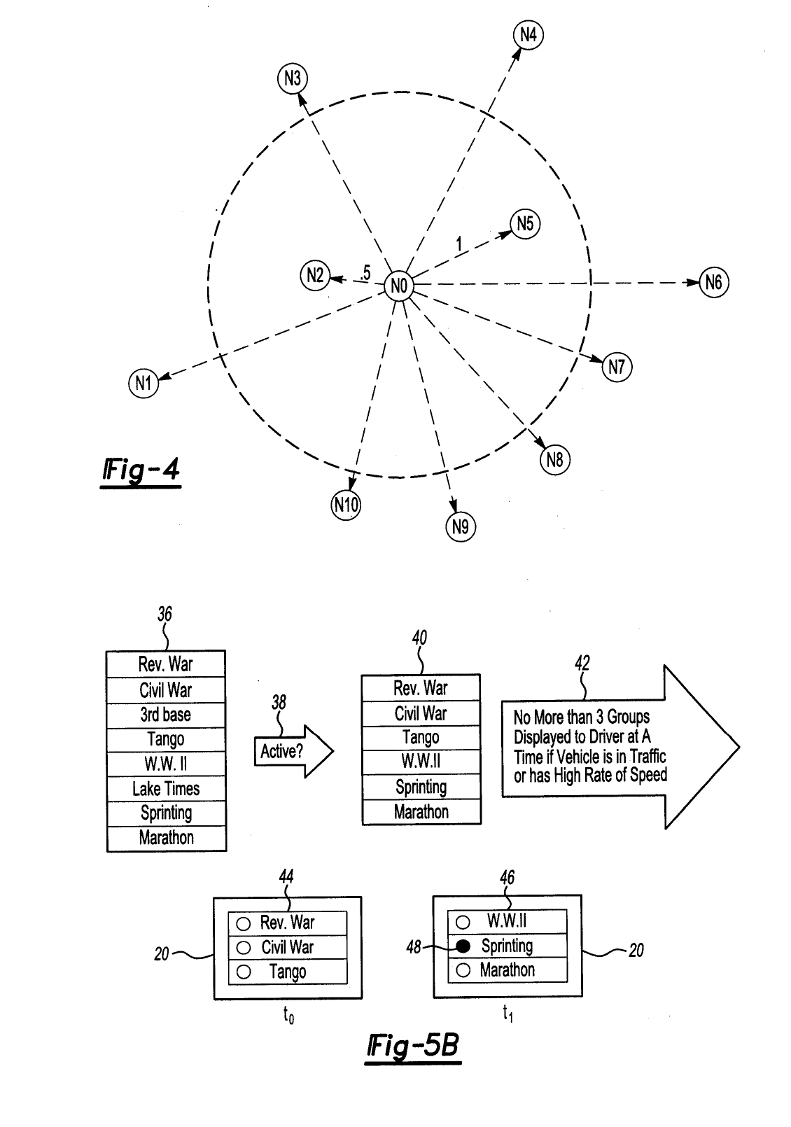

FIG. 4 is a graphical representation of the similarity of interests between the occupant and the members of the circle of friends of the occupant. Those friends who share more interests with the occupant are located closer to the occupant. For example, from the above, N2 is located 0.5 away from N0 whereas N5 is located 1 away from N0. This, or another, e.g., bar chart, etc., representation is displayed to the occupant via display 20 for their selection. In alternative embodiments, such a representation need not be displayed as computing platform 10 may select friends with similar interests based on how similar, e.g., less than or equal to 1, they are to the occupant.

FIG. 5A is a tabular representation of discussion groups to which N2 and N5 subscribe. Network servers 22 hold similar information for most or all of the circle of friends. N2 belongs to rev war, civil war, 3rd base, and tango discussion groups. N5 belongs to WWII, lake times, sprinting, and marathon discussion groups. Based on the selection of the friends with similar interests above, these discussion groups are communicated from network servers 22 to computing platform 10 via telematics gateway 14.

FIG. 5B is a series of tabular representations of the discussion groups of FIG. 5A. At 36, computing platform 10 sorts the discussion groups according to the selected member sharing the most interests with the occupant, e.g., N2's discussion groups are followed by N3's discussion groups. At 38, computing platform 10, via telematics gateway 14, then determines which of these discussion groups are currently in use by, for example, querying the respective servers 22 hosting the discussion groups. Once complete, at 40, computing platform tabulates those discussion groups that are currently in use, e.g., rev war, civil war, tango, WWII, sprinting, and marathon. At 42, computing platform applies a rule prior to displaying any discussion groups to the occupant. In this example, the rule limits the number of discussion groups displayed at one time if the vehicle is in heavy traffic, as indicated by, for example, frequent acceleration and/or deceleration, or has a high rate of speed. This rule may be occupant selected and input during a configuration of computing platform 10 by the occupant via, for example, display 20, e.g., touch screen, or by voice command. Because, in this example, vehicle 12 has a high rate of speed, at 44, which is at time t₀, rev war, civil war, and tango discussion groups are displayed to the occupant via display 20. At 46, which is at time t₁, WWII, sprinting, and marathon discussion groups are displayed to the occupant via display 20. The occupant may toggle between the screens via voice commands or touch input. In this example, the occupant is permitted to select a discussion group by touching the screen of display 20, at, for example, 48. In alternative embodiments, the discussion groups may be read to the occupant via, for example, a text to speech device.

Once the occupant selects a discussion group to join, computing platform 10 and telematics gateway 14 establish a connection to the server hosting the discussion group as explained above.

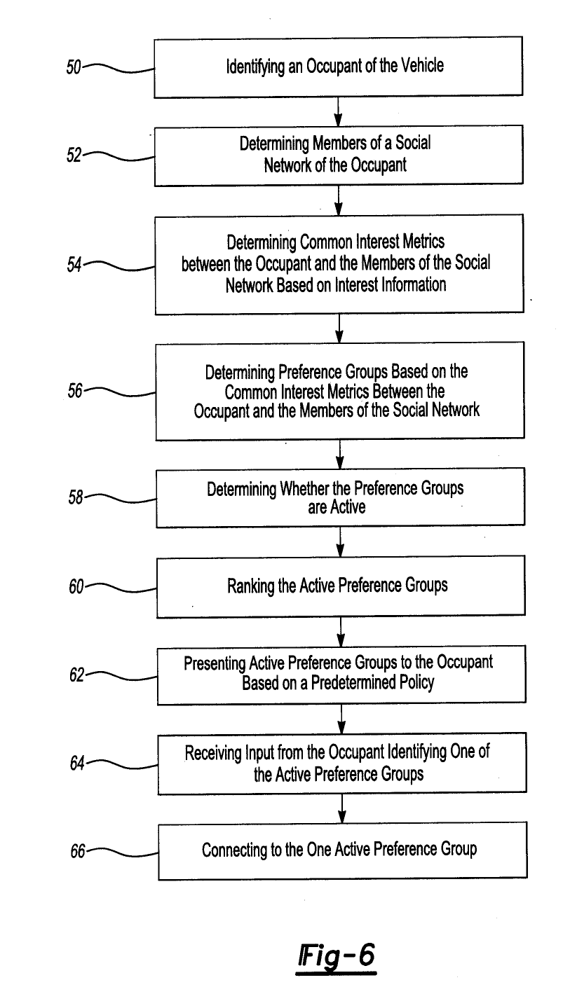

FIG. 6 is a method for selecting an active preference group. At 50, an occupant of the vehicle is identified. At 52, members of a social network of the occupant are determined. At 54, common interest metrics between the occupant and members of the social network are determined based on interest information. At 56, preference groups are determined based on the common interest metrics between the occupant and the members of the social network. At 58, whether the preference groups are active is determined. At 60, the active preference groups are ranked. At 62, the active preference groups are presented to the occupant based on a predetermined policy. At 64, input from the occupant is received identifying one of the active preference groups. At 66, the occupant is connected to the one active preference group.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method for selecting, in a vehicle including a communication module, an active preference group, the method comprising:
receiving an occupant identifier;
retrieving members of a social network associated with the occupant identifier;
retrieving interest information associated with the occupant identifier;
retrieving interest information associated with the members of the social network;
retrieving preference groups associated with the members of the social network;
determining common interest metrics between an occupant associated with the occupant identifier and each member of the social network;
selecting preference groups based on the common interest metrics;
determining whether the selected preference groups are active;
presenting active preference groups;
receiving input selecting one of the active preference groups; and
connecting the communication module with a host of the selected one active preference group.

2. The method of claim 1 wherein the common interest metrics are based on the interest information associated with the occupant identifier and the members of the social network.

3. The method of claim 2 wherein determining common interest metrics between the occupant and each member of the social network includes determining a number of interests shared by the occupant and a member of the social network.

4. The method of claim 1 wherein the active preference groups are presented based on a predetermined policy.

5. The method of claim 4 wherein the predetermined policy is based on a state of the vehicle.

6. The method of claim 5 wherein the state of the vehicle comprises vehicle speed.

7. The method of claim 4 wherein the predetermined policy comprises a limit on the number of active preference groups presented.

8. The method of claim 4 wherein the predetermined policy comprises a user specified policy.

9. The method of claim 1 further comprising ranking the active preference groups.

10. The method of claim 1 wherein the common interest metrics are a measure of a number of interests shared by the occupant and the members of the social network.

11. A system for selecting, in a vehicle, an active preference group, the system comprising:
an identification module configured to receive an occupant identifier;
a communication module configured to
retrieve members of a social network associated with the occupant identifier,
retrieve interest information associated with the occupant identifier,
retrieve interest information associated with the members of the social network,
retrieve preference groups associated with the members of the social network, and
connect with a host of a selected active preference group;
a processing module configured to
determine common interest metrics between an occupant associated with the occupant identifier and each member of the social network,
select preference groups based on the common interest metrics, and
determine whether the selected preference groups are active;
a presentation module configured to present active preference groups; and
an input module configured to receive input selecting one of the active preference groups.

12. The system of claim 11 wherein the common interest metrics are based on the interest information associated with the occupant identifier and the members of the social network.

13. The system of claim 12 wherein the processing module determines the common interest metrics between the occupant and each member of the social network based on a number of interests shared by the occupant and each member of the social network.

14. The system of claim 11 wherein the active preference groups are presented based on a predetermined policy.

15. The system of claim 14 wherein the predetermined policy is based on a state of the vehicle.

16. The system of claim 15 further comprising a vehicle speed sensor wherein the state of the vehicle comprises vehicle speed.

17. The system of claim 14 wherein the predetermined policy comprises a limit on the number of active preference groups presented.

18. The system of claim 14 wherein the predetermined policy comprises a user specified policy.

19. The system of claim 11 wherein the processing module is further configured to rank the active preference groups.

20. The system of claim 11 wherein the common interest metrics are a measure of a number of interests shared by the occupant and the members of the social network.
